(19) United States
(12) Patent Application Publication
(10) Pub. No.: US 2011/0284805 A1
(43) Pub. Date: Nov. 24, 2011

(54) PRODUCTION OF MECHANICALLY EXFOLIATED GRAPHENE AND NANOPARTICLE COMPOSITES COMPRISING SAME

(75) Inventors: Edward T. SAMULSKI, Chapel Hill, NC (US); Yongchao SI, Chapel Hill, NC (US)

(73) Assignee: THE UNIVERSITY OF NORTH CAROLINA AT CHAPEL HILL, Chapel Hill, NC (US)

(21) Appl. No.: 13/150,812

(22) Filed: Jun. 1, 2011

Related U.S. Application Data
(63) Continuation-in-part of application No. 12/993,948, filed on Jan. 25, 2011.
(60) Provisional application No. 61/055,447, filed on May 22, 2008.

(51) Int. Cl. H01B 1/04; H01B 1/24; C01B 31/02; H01B 1/02; C01B 31/00; C01G 55/00

(52) U.S. Cl. 252/503; 423/414; 423/445 R; 423/439; 423/448; 252/502; 252/506; 252/511

(57) ABSTRACT

A method for producing nanospacer-graphene composite materials (i.e., mechanically-exfolitated graphene), wherein the graphene sheets are interspersed with nanospacers, thereby maintaining the 2D characteristics of the graphene sheets. The nanospacer-graphene composite material is highly porous, has a high surface area and is highly electrically conductive and may be optically transparent.

### CROSS-REFERENCE TO RELATED APPLICATIONS

This application is a Continuation in Part of and claims priority to U.S. patent application Ser. No. 12/993,948, filed on Nov. 22, 2010 which in turn claims priority to PCT International Application No. PCT/US09/44939, filed on May 22, 2009, which in turn claims priority to U.S. Provisional Patent Application No. 61/055,447, filed on May 22, 2008, the contents of which are all hereby incorporated by reference herein.

### GOVERNMENT RIGHTS

The United States Government has rights to this invention pursuant to National Science Foundation STTR grant number IIP-0930099 and National Science Foundation SBIR grant number HP-1013345.

### FIELD

This invention relates generally to composites comprising graphene sheets and nanospacers and methods of making and using same.

### Description of the Related Art

Graphite nanoplatelets have recently attracted considerable attention as a viable and inexpensive filler substitute for carbon nanotubes in nanocomposites, given the predicted excellent in-plane mechanical, structural, thermal, and electrical properties of graphite. Graphite nanoplatelets in the form of graphene sheets are now known and each comprises a one-atom thick, two dimensional layer of hexagonally-arrayed sp²-bonded carbon atoms having a theoretical specific surface area of about 2600 m² g⁻¹. Although it is only one atom thick and unprotected from the immediate environment, graphene exhibits high crystal quality and ballistic transport at submicron distances. Moreover, graphene can be light, highly flexible and mechanically strong (resisting tearing by AFM tips), and the material's dense atomic structure should make it impermeable to gases. Graphene layers or sheets are predicted to exhibit a range of possible advantageous properties such as high thermal conductivity and electronic transport that rival the remarkable in-plane, like-properties of bulk graphite. Accordingly, graphene sheets may be useful in many applications such as supercapacitors, batteries, fuel cells, composite materials, emissive displays, transparent conducting electrodes, micromechanical resonators, transistors, and ultra-sensitive chemical detectors.

Disadvantageously, the properties of graphene rapidly devolve with the number of layers, approaching the 3-dimensional limit of graphite at about ten layers. Once above ten layers, the graphene is considered a thin film of graphite. In a dispersion, functionalized graphene sheets are well separated from each other by solvent and electrostatic forces and exist in isolated sheets. However, like other nanomaterials with a high aspect ratio, once dry, graphene sheets tend to aggregate and form the irreversible graphitic agglomerate.

One possible route to harnessing the advantageous properties of graphene for potential applications is to incorporate graphene sheets in a homogeneous distribution in a composite material. One approach to repress graphene's tendency to aggregate is to use nano-spacers to keep the planar sheets separated. By functioning as the nano-spacers, the nanoparticles separate the graphene sheets, keeping them from forming short range ordered structure. Accordingly, high specific surface area as well as other unique properties possessed by 2D graphene could be retained even in the dry state.

We present herein a process that is capable of chemically mass-producing high surface area, highly porous graphene sheets from oxidized graphite. Nanospacers can be incorporated into the graphene in the form of nanoparticles. Alternatively, nanospacers can be incorporated into graphene during the reduction of graphite oxide into graphene.

### SUMMARY

The present invention generally relates to the minimization of the aggregation of graphene sheets by incorporating same with nanospacers, e.g., nanoparticles, resulting in the formation of a high surface area nanospacer-graphene composite material referred to as mechanically-exfoliated graphene.

In one aspect, a nanospacer-graphene composite material is described, wherein the nanospacer comprises a nanoparticle selected from the group consisting of fullerenes, carbon nanotubes, mesoporous graphite, carbon aerogel, activated carbon, acetylene black, carbon black, graphite, nanodiamonds, lamp black, activated carbon, metal nanoparticles, metal oxides nanoparticles, ceramic nanoparticles, silicon nanoparticles, silicon oxide nanoparticles, polymeric particles, glasses, powders, and any combination thereof. The graphene need not be functionalized with sulfonate moieties.

In another aspect, a process of producing nanospacer-graphene composite material is described, said process comprising:
mixing exfoliated graphene oxide with nanospacer material; and
reducing the exfoliated graphene oxide in the presence of nanospacer material to form the nanospacer-graphene composite material.

In still another aspect, a process of producing nanospacer-graphene composite material is described, said process comprising:
mixing exfoliated graphene oxide with at least one metal-containing precursor; and
reducing the exfoliated graphene oxide in the presence of at least one metal-containing precursor to form the nanospacer-graphene composite material,
   wherein the graphene is not functionalized with sulfonate moieties.

Other aspects, features and embodiments will be more fully apparent from the ensuing disclosure and appended claims.

### BRIEF DESCRIPTION OF THE DRAWINGS

FIG. 1 is a schematic of a process of producing nanospacer-graphene composite materials.

FIG. 2 is a schematic of another process of producing nanospacer-graphene composite materials.

FIG. 3 is SEM images of the nanospacer-graphene composite material having carbon nanotubes as nanospacers.

FIG. 4 is SEM images of the nanospacer-graphene composite material having acetylene black as nanospacers.

FIG. 5 is SEM images of the nanospacer-graphene composite material having platinum metal as nanospacers.

FIG. 6 is an SEM image of the nanospacer-graphene composite material having platinum metal as nanospacers.

FIG. 7 is a Pt4f spectrum of the Pt-graphene composite material relative to commercial Pt-carbon black catalyst.

FIG. 8 is an XRD pattern of the Pt-graphene composite material.

### DETAILED DESCRIPTION, AND PREFERRED EMBODIMENTS THEREOF

The present invention generally relates to the formation of high surface area nanoparticle-graphene composite material. Nanospacers can be incorporated into the graphene to form the nanoparticle-graphene composite material, i.e., the mechanically-exfoliated graphene. Alternatively, nanospacers can be incorporated into graphene during the reduction of graphite oxide into graphene.

As used herein, the term “graphene” refers to a molecule in which a plurality of carbon atoms (e.g., in the form of five-membered rings, six-membered rings, seven-membered and/or higher number rings) are covalently bound to each other to form a (typically sheet-like) polycyclic aromatic molecule. Consequently, and at least from one perspective, graphene may be viewed as a single layer of carbon atoms that are covalently bound to each other (most typically sp² bonded). It should be noted that such sheets may have various configurations, and that the particular configuration will depend (among other things) on the amount and position of odd-membered rings in the sheet. For example, an otherwise planar graphene sheet consisting of six-membered rings will warp into a cone shape if a five-membered ring is present the plane, or will warp into a saddle shape if a seven-membered ring is present in the sheet. Furthermore, and especially where the sheet-like graphene is relatively large, it should be recognized that the graphene may fold and undulate to have the electron-microscopic appearance of a wrinkled sheet. It should be further noted that under the scope of this definition, the term “graphene” also includes molecules in which several (e.g., two, three, four, five to ten, one to twenty, one to fifty, or one to hundred) single layers of carbon atoms (supra) are stacked on top of each other to a maximum thickness of less than 100 nanometers. Consequently, the term “graphene” as used herein refers to a single layer of aromatic polycyclic carbon as well as to a plurality of such layers stacked upon one another and having a cumulative thickness of less than 100 nanometers.

As defined herein, “substantially devoid” corresponds to less than about 2 wt. %, more preferably less than 1 wt. %, and most preferably less than 0.1 wt. % of the process solution or product, based on the total weight of said process solution or product.

As defined herein, “agitation” corresponds to sonication as well as other agitation means such as stirring and shaking.

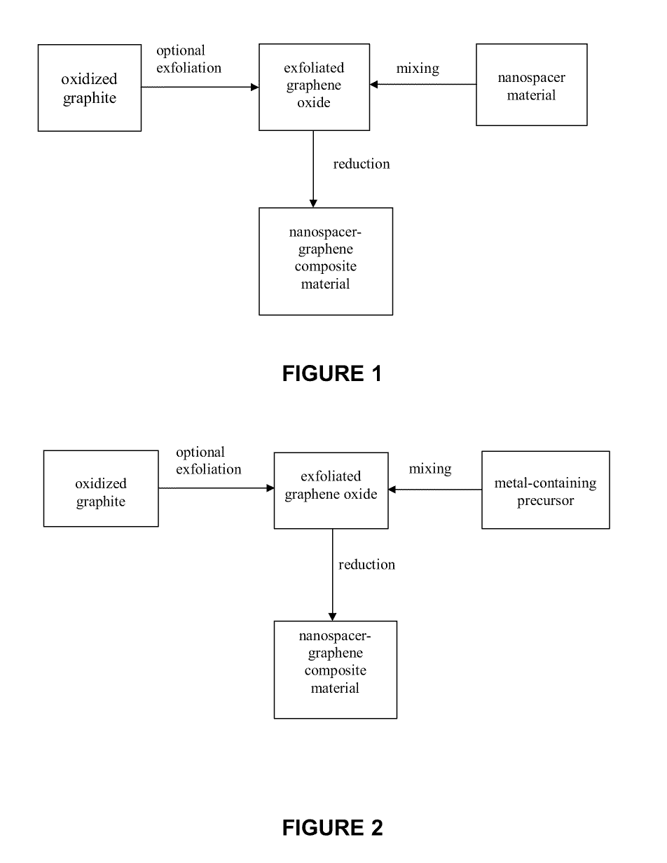

In a first aspect, a process of producing a nanospacer-graphene composite material is described, said process comprising:
mixing exfoliated graphene oxide with nanospacer material; and
reducing the exfoliated graphene oxide in the presence of nanospacer material to form the nanospacer-graphene composite material.
   The process can further comprise a thermal processing step wherein the nanospacer-graphene composite material is thermally processed at high temperatures in an inert atmosphere or vacuum. The process can also further comprise the production of the exfoliated graphene oxide by agitating graphite oxide to produce said exfoliated graphene oxide. The graphite oxide may be purchased or may be prepared by oxidizing graphite with acid. The produced nanospacer-graphene composite material is considered to be mechanically exfoliated. The process of the first aspect is shown graphically in FIG. 1.

Accordingly, in one embodiment of the first aspect, the process of producing a nanospacer-graphene composite material comprises:
agitating graphite oxide to produce exfoliated graphene oxide;
mixing exfoliated graphene oxide with nanospacer material; and
reducing the exfoliated graphene oxide in the presence of nanospacer material to form the nanospacer-graphene composite material.
   The graphite oxide may be purchased or may be prepared by oxidizing graphite with acid. The produced nanospacer-graphene composite material is considered to be mechanically exfoliated.

In another embodiment of the first aspect, the process of producing a nanospacer-graphene composite material comprises:
mixing exfoliated graphene oxide with nanospacer material;
reducing the exfoliated graphene oxide in the presence of nanospacer material to form the nanospacer-graphene composite material; and
thermally processing the nanospacer-graphene composite material at high temperatures in an inert atmosphere or vacuum.
   The graphene oxide may be purchased or may be prepared by agitating graphite oxide to produce said exfoliated graphene oxide. The produced nanospacer-graphene composite material is considered to be mechanically exfoliated.

In yet another embodiment of the first aspect, the process of producing a nanospacer-graphene composite material comprises:
agitating graphite oxide to produce exfoliated graphene oxide;
mixing exfoliated graphene oxide with nanospacer material;
reducing the exfoliated graphene oxide in the presence of nanospacer material to form the nanospacer-graphene composite material; and
thermally processing the nanospacer-graphene composite material at high temperatures in an inert atmosphere or vacuum.
   The graphite oxide may be purchased or may be prepared by oxidizing graphite with acid. The produced nanospacer-graphene composite material is considered to be mechanically exfoliated.

When the process includes the step of agitating graphite oxide to produce exfoliated graphene oxide, the graphite oxide can be agitated, e.g., sonicated, in at least one solvent to produce the exfoliated graphene oxide. Solvents contemplated include water or water and water miscible organic solvents including alcohols, carbonates, glycols, glycol ethers, and combinations thereof, such as methanol, ethanol, isopropanol, butanol, and higher alcohols (including diols, triols, etc.), 4-methyl-2-pentanol, ethylene glycol, propylene glycol, butylene glycol, butylene carbonate, ethylene carbonate, propylene carbonate, dipropylene glycol, diethylene glycol monomethyl ether, triethylene glycol monomethyl ether, diethylene glycol monoethyl ether, triethylene glycol monoethyl ether, ethylene glycol monopropyl ether, ethylene glycol monobutyl ether, diethylene glycol monobutyl ether (i.e., butyl carbitol), triethylene glycol monobutyl ether, ethylene glycol monohexyl ether, diethylene glycol monohexyl ether, ethylene glycol phenyl ether, propylene glycol methyl ether, dipropylene glycol methyl ether (DPGME), tripropylene glycol methyl ether, dipropylene glycol dimethyl ether, dipropylene glycol ethyl ether, propylene glycol n-propyl ether, dipropylene glycol n-propyl ether (DPGPE), tripropylene glycol n-propyl ether, propylene glycol n-butyl ether, dipropylene glycol n-butyl ether, tripropylene glycol n-butyl ether, propylene glycol phenyl ether, and combinations thereof. Preferably, the solvent comprises water, most preferably deionized water. Conditions of sonication include time in a range from about 10 minutes to about 6 hours, preferably about 1 hr to about 3 hr, at temperature in a range from about 20° C. to about 60° C., preferably about about 20° C. to about 30° C. The amount of graphite per volume of solvent is readily determinable by the skilled artisan and can be in a range from about 1 g graphite per about 100 mL to about 1000 mL of solvent. Thereafter, the exfoliated graphene oxide can be mixed with the nanospacer material.

When the process starts with commercially prepared exfoliated graphene oxide, the exfoliated graphene oxide can be mixed with at least one of the aforementioned solvents and the nanospacer material. Preferably, the solvent comprises water. The amount of graphene oxide per volume of solvent is readily determinable by the skilled artisan and can be in a range from about 1 g graphene oxide per about 100 mL to about 1000 mL of solvent.

Nanospacers can include: carbon allotropes such as fullerenes, carbon nanotubes, mesoporous graphite, carbon aerogel, activated carbon, acetylene black, carbon black (e.g., VULCAN®, BLACK PEARLS®, ENSACO®, KETJENBLACK®, MONARCH®, REGAL®, ELFTEX®), ex graphite, nanodiamonds, lamp black, activated carbon, or any combination thereof; metal nanoparticles such as Pt, Ag, Au, Cu, Ni, Al, Co, Cr, Fe, Mn, Zn, Cd, Sn, Pd, Ru, Os, Ir or any combination thereof; metal oxides nanoparticles such as TiO₂, ZnO, Al₂O₃, MnO₂, RuO₂, PbO₂, NiOOH, or any combination thereof; ceramic nanoparticles; silicon nanoparticles; silicon oxide nanoparticles; polymeric particles; glasses such as silicon oxide; powders such as talc (hydrated magnesium silicate); or any combination of any of the nanoparticles disclosed herein. The amount of nanospacer material mixed with exfoliated graphene oxide is in a range from about 0.01 wt % to about 50 wt %, based on the total weight of the mixture.

The exfoliated graphene oxide can be reduced using at least one reducing agent selected from the group consisting of alkali metal borohydrides, alkali metal cyanoborohydrides, quaternary ammonium borohydrides and amine boranes such as lithium borohydride (LiBH₄), sodium borohydride (NaBH₄), potassium borohydride (KBH₄), rubidium borohydride (RbBH₄), cesium borohydride (CsBH₄), lithium cyanoborohydride (LiBH₃CN), sodium cyanoborohydride (NaBH₃CN), potassium cyanoborohydride (KBH₃CN), rubidium cyanoborohydride (RbBH₃CN), cesium cyanoborohydride (CsBH₃CN), ammonium borohydride (NH₄BH₄), tetramethylammoniumborohydride((CH₃)₄NBH₄), dimethylaminoborane((CH₃)₂NHBH₃), N,N-diethylanilineborane(C₆H₅N(C₂H₅)₂BH₃), pyridine borane (C₅H₅NBH₃), hydrazine, 1,1-dimethylhydrazine, 1,2-dimethylhydrazine, 1,1-diethylhydrazine, 1,2-diethylhydrazine, 1-ethyl-2-methylhydrazine, 1-acetyl-2-methylhydrazine, 1,1-diethyl-2-propylhydrazine, hydrazine sulfate, sulfonated hydrazine derivatives, and combinations thereof. In a particularly preferred embodiment, the reducing agent comprises hydrazine. The reduction process may be carried out at temperature in a range from about 30° C. to about 150° C., preferably about 50° C. to about 100° C. for time in a range from about 10 minutes to about 20 hours, preferably about 30 minutes to about 2 hours. The concentration of reducing agent can be in a range from about 0.01 M to about 1 M, preferably about 0.01 M to about 0.2 M.

It should be appreciated that the reduction mixture comprising the exfoliated graphene oxide, the solvent, the nanospacer material and the reducing agent(s) can further comprise at least one pH adjusting agent, at least one surfactant, or both at least one pH adjusting agent and at least one surfactant. pH adjusting agents include species such as NaOH, KOH, HCl, H₂SO₄, HSO₄⁻, HNO₃, H₃PO₄, H₂PO₄⁻, HPO₄²⁻, H₂CO₃, HCO₃⁻, and corresponding salts thereof, and organic acids such as one or more of oxalic acid, formic acid, succinic acid, malic acid, malonic acid, citric acid, dodecylbenzenesulfonic acid (DDBSA), glycolic acid, nitrilotris(methylene)triphosphoric acid (NTMTP), acetic acid, lactic acid, salicylic acid, glycine, ascorbic acid, gallic acid, phthalic acid, tartaric acid, benzoic acid, fumaric acid, mandelic acid, trifluoroacetic acid, propionic acid, aspartic acid, glutaric acid, gluconic acid, salts thereof, and combinations thereof. Preferred pH adjusting agents include sodium bicarbonate. Most preferably, the pH is adjusted in a range from about 5 to about 9, more preferably about 6 to about 8. Surfactants are preferably added to control the size of the metal nanospacers and also prevent said metal nanospacers from aggregation during reduction. Surfactants contemplated include nonionic, anionic, cationic (based on quaternary ammonium cations) and/or zwitterionic surfactants. For example, suitable non-ionic surfactants may include fluoroalkyl surfactants, ethoxylatedfluorosurfactants, polyethylene glycols, polypropylene glycols, polyethylene or polypropylene glycol ethers, carboxylic acid salts, dodecylbenzenesulfonic acid or salts thereof, polyacrylate polymers, dinonylphenylpolyoxyethylene, silicone or modified silicone polymers, acetylenic diols or modified acetylenic diols, alkylammonium or modified alkylammonium salts, and alkylphenolpolyglycidol ether, as well as combinations of the foregoing. Anionic surfactants contemplated in the compositions of the present invention include, but are not limited to, fluorosurfactants, sodium alkyl sulfates such as sodium ethylhexyl sulfate, ammonium alkyl sulfates, alkyl (C₁₀-C₁₈) carboxylic acid ammonium salts, sodium sulfosuccinates and esters thereof, e.g., dioctyl sodium sulfosuccinate, alkyl (C₁₀-C₁₈) sulfonic acid sodium salts, and the di-anionic sulfonate surfactants. Cationic surfactants contemplated include alkylammonium salts such as cetyltrimethylammonium bromide (CTAB) and cetyltrimethylammonium hydrogen sulfate. Suitable zwitterionic surfactants include ammonium carboxylates, ammonium sulfates, amine oxides, N-dodecyl-N,N-dimethylbetaine, betaine, sulfobetaines such as 3-(N,N-dimethyldodecylammonio)propane sulfonate, carnitine, alkylammoniopropyl sulfate, and the like. Alternatively, the surfactants may include water soluble polymers including, but not limited to, polyethylene glycol (PEG), polyethylene oxide (PEO), polypropylene glycol (PPG), polyvinyl pyrrolidone (PVP), cationic polymers, nonionic polymers, anionic polymers, hydroxyethylcellulose (HEC), acrylamide polymers, poly(acrylic acid), carboxymethylcellulose (CMC), sodium carboxymethylcellulose (Na CMC), hydroxypropylmethylcellulose, polyvinylpyrrolidone K30, BIOCARE™ polymers, DOW™ latex powders (DLP), ETHOCEL™ ethylcellulose polymers, KYTAMER™ PC polymers, METHOCEL™ cellulose ethers, POLYOX™ water soluble resins, SoftCAT™ polymers, UCARE™ polymers, UCON™ fluids, PPG-PEG-PPG block copolymers, PEG-PPG-PEG block copolymers, and combinations thereof. The water soluble polymers may be short-chained or long-chained polymers and may be combined with the nonionic, anionic, cationic, and/or zwitterionic surfactants of the invention. Preferred surfactants include 3-(N,N-dimethyldodecylammonio)propane sulfonate. When present, a stoichiometric ratio of one (1) surfactant molecule to one (1) metal-containing precursor is preferred to inhibit metal nanoparticle aggregation during reduction although the stoichiometric range may be from 1:10 to 10:1, as readily determined by one skilled in the art.

Following the formation of the nanospacer-graphene composite material, said material can be separated from the mother liquor and rinsed with a rinsing media. The nanospacer-graphene composite material can be dried or stored in a suitable solvent. Suitable solvents include the aforementioned solvents, preferably water. Separation techniques include centrifugation and filtration. Rinsing can be done using rinsing media such as the aforementioned solvents. Preferably, the rinsing media comprises water.

When the process includes the step of thermally processing the nanospacer-graphene composite material, conditions of the thermal process include temperature in a range from about 500° C. to about 1000° C., preferably about 700° C. to about 900° C. for time in a range from about 10 minutes to about 6 hours, preferably about 1 hour to about 3 hours, as readily determinable by the skilled artisan based on the nature of the nanospacer. The thermal processing preferably occurs in an inert environment, e.g., in the presence of nitrogen.

An alternative to thermal processing is drying the nanospacer-graphene composite material subsequent to the rinse. Drying conditions include temperature in a range from about 40° C. to about 100° C. for time in a range from about 1 hour to about 24 hours, preferably about 1 hour to about 15 hours.

In a second aspect, a process of producing a nanospacer-graphene composite material is described, said process comprising:
mixing exfoliated graphene oxide with at least one metal-containing precursor; and
reducing the exfoliated graphene oxide in the presence of at least one metal-containing precursor to form the nanospacer-graphene composite material,
   wherein the graphene is not functionalized with any sulfonate moieties. The process can further comprise a thermal processing step wherein the nanospacer-graphene composite material is thermally processed at high temperatures in an inert atmosphere or vacuum. The process can also further comprise the production of the exfoliated graphene oxide by agitating graphite oxide to produce said exfoliated graphene oxide. The graphite oxide may be purchased or may be prepared by oxidizing graphite with acid. The produced nanospacer-graphene composite material is considered to be mechanically exfoliated. The process of the second aspect is shown graphically in FIG. 2.

Accordingly, in one embodiment of the second aspect, the process of producing a nanospacer-graphene composite material comprises:
agitating graphite oxide to produce exfoliated graphene oxide;
mixing exfoliated graphene oxide with at least one metal-containing precursor; and
reducing the exfoliated graphene oxide in the presence of the at least one metal-containing precursor to form the nanospacer-graphene composite material,
   wherein the graphene is not functionalized with any sulfonate moieties. The graphite oxide may be purchased or may be prepared by oxidizing graphite with acid. The produced nanospacer-graphene composite material is considered to be mechanically exfoliated.

In another embodiment of the second aspect, the process of producing a nanospacer-graphene composite material comprises:
mixing exfoliated graphene oxide with at least one metal-containing precursor;
reducing the exfoliated graphene oxide in the presence of the at least one metal-containing precursor to form the nanospacer-graphene composite material; and
thermally processing the nanospacer-graphene composite material at high temperatures in an inert atmosphere or vacuum,
   wherein the graphene is not functionalized with any sulfonate moieties. The graphene oxide may be purchased or may be prepared by agitating, e.g., sonicating, graphite oxide to produce said exfoliated graphene oxide. The produced nanospacer-graphene composite material is considered to be mechanically exfoliated.

In yet another embodiment of the second aspect, the process of producing a nanospacer-graphene composite material comprises:
agitating graphite oxide to produce exfoliated graphene oxide;
mixing exfoliated graphene oxide with at least one metal-containing precursor;
reducing the exfoliated graphene oxide in the presence of the at least one metal-containing precursor to form the nanospacer-graphene composite material; and
thermally processing the nanospacer-graphene composite material at high temperatures in an inert atmosphere or vacuum,
   wherein the graphene is not functionalized with any sulfonate moieties. The graphite oxide may be purchased or may be prepared by oxidizing graphite with acid. The produced nanospacer-graphene composite material is considered to be mechanically exfoliated.

The solvent and the reducing agent(s) of the second aspect, as well as the amounts of each, are the same as those disclosed for the first aspect. Preferred solvents comprise water, most preferably deionized water. Preferred reducing agents comprise hydrazine. The conditions of each step of the process of the second aspect are the same as those disclosed for the first aspect.

Metal-containing precursors include at least one metal ion selected from the group consisting of Pt, Ag, Au, Cu, Ni, Al, Co, Cr, Fe, Mn, Zn, Cd, Sn, Pd, Ru, Os, Ir or any combination thereof. Counterions of the metal ion can comprise at least one ligand selected from the group consisting of fluoride, chloride, bromide, iodide, β-diketones, nitrate, nitrite, nitride, oxide, oxalate, sulfate, sulfite, sulfide, phosphate, phosphite, phosphide, hydroxide, carbonyl, water, cyanide, ammonia, phosphine, hydroxyl, selenide, and any combination thereof. For example, the metal-containing precursor can comprise the hexachloroplatinate ion (PtCl₆²⁻).

It should be appreciated that the reduction mixture of the second aspect comprising the exfoliated graphene oxide, the solvent, the at least one metal-containing precursor, and the reducing agent(s) can further comprise at least one pH adjusting agent, at least one surfactant, or both at least one pH adjusting agent and at least one surfactant. The pH adjusting agents and surfactants can be the same as those disclosed in the first aspect.

The processes described herein are scalable so that large quantities of nanospacer-graphene composite material can be prepared which is a substantial advantage over methods known in the art.

At the completion of the process of producing the nanospacer-graphene composite material, a novel nanospacer-graphene composite material exists regardless of whether the method of the first aspect or the second aspect was followed. Advantageously, the nanospacer-graphene composite materials:
comprise nanospacers physisorbed or chemisorbed to the 2D graphene sheets thereby reducing the aggregation typical of graphene sheets substantially devoid of said nanospacers;
are highly porous and have a high surface area (approximately 500 m² g⁻¹); and
can have an electrical conductivity higher than that of plain graphene (e.g., about 2 to about 5 times greater).

Accordingly, a third aspect relates to the novel nanospacer-graphene composite materials. More preferably, the novel nanospacer-graphene composite materials comprise graphene that is not functionalized with sulfonate groups.

The graphene sheets described herein may be useful in applications such as, but not limited to, supercapacitors, batteries, fuel cells, composite materials, emissive displays, micromechanical resonators, transistors, and ultra-sensitive chemical detectors.

In a fourth aspect, the nanospacer-graphene composite material described herein is blended in a polymer matrix to form a graphene-polymer composite. The process of making a graphene-polymer composite comprises blending the nanospacer-graphene composite material with a solution of a polymer, and solidifying the graphene-polymer mixture to form the graphene-polymer composite.

The term “polymer” includes homopolymers and copolymers comprising polymerized monomer units of two or more monomers. Preferred organic polymers include homopolymers, copolymers, random polymers block copolymers, dendrimers, statistical polymers linear, branched, star-shaped, dendritic polymers, segmented polymers and graft copolymers. Two or more polymers may be combined as blends or in copolymers. The polymers may be crosslinked using known crosslinkers such as monomers having at least two ethylenically unsaturated groups or alkoxysilanes. The polymers contemplated include poly(ether imide) (PEI), polystyrene, polyacrylates (such as polymethylacrylate), polymethacrylates (such as polymethylmethacrylate (PMMA)),polydienes (such as polybutadiene), polyalkyleneoxides (such as polyethyleneoxide), polyvinylethers, polyalkylenes, polyesters, polycarbonates, polyamides, polyurethanes, polyvinylpyrrolindone, polyvinylpyridine, polysiloxanes, polyacrylamide, epoxy polymers, polythiophene, polypyrrole, polydioxythiophene, polydioxypyrrole, polyfluorene, polycarbazole, polyfuran, polydioxyfuran, polyacetylene, poly(phenylene), poly(phenylene-vinylene), poly(aryleneethynylene), polyaniline, polypyridine, polyfluorene, polyetheretherketone, polyamide-imide, polysulfone, polyphenylsulfone, polyethersulfone, polyphthalamide, and polyarylamide. The polymer solutions necessary to produce said polymers are well known to those skilled in the art. Preferably, the graphene is uniformly and homogeneously distributed throughout the polymer matrix.

The graphene-polymer composites possess remarkable thermal, mechanical and electric properties and as such, may be used in the development of new coatings for use in a variety of technologies and applications.

The features and advantages of the invention are more fully illustrated by the following non-limiting examples, wherein all parts and percentages are by weight, unless otherwise expressly stated.

### Example 1

Graphite oxide prepared from natural graphite flakes (325 mesh, Alfa-Aesar) by Hummer's method was used as the starting material. In a typical procedure, 1 g of graphite oxide was dispersed in 500 g water. After sonication for 2 hours a clear, brown dispersion of graphene oxide was formed. Thereafter, 50 mg of multi-walled carbon nanotubes was added to the graphene oxide dispersion with stirring. 1 g of hydrazine in 5 grams of water having a pH of about 7-8 (adjusted with NaHCO₃) was added to the mixture. The mixture was maintained at about 80° C. for 1 hr under constant stirring. During reduction, the dark brown dispersion turned black and aggregation was observed at the end of the reduction step. Nanospacer-graphene composite material was separated from the dispersion by filtration. After rinsing with water several times, the nanospacer-graphene composite material was thermally treated in nitrogen at 800° C. for 2 hrs.

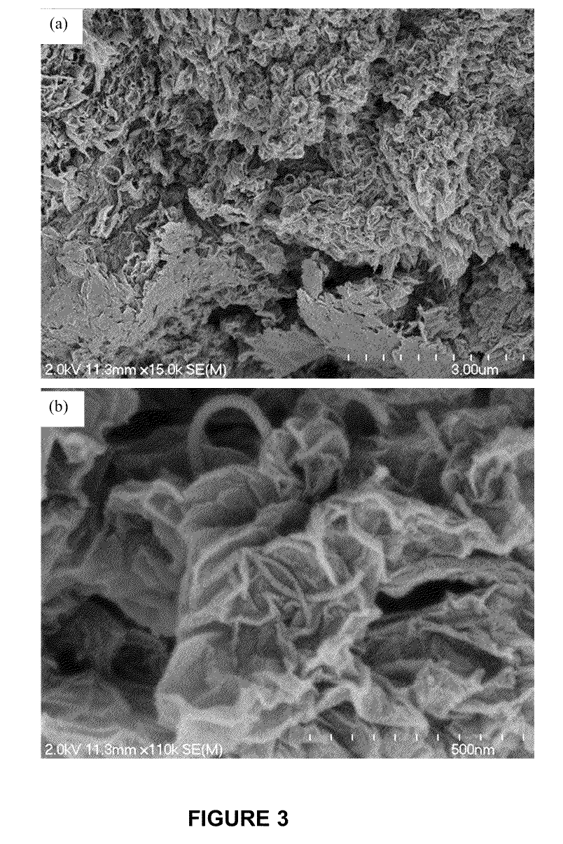

Referring to FIG. 3, scanning electron microscopy (SEM) images of the nanospacer-graphene composite material having carbon nanotubes as nanospacers can be seen. It can be seen that the carbon nanotubes are easily seen in FIG. 3(b) and that the material is a highly porous structure.

### Example 2

Graphite oxide prepared from natural graphite flakes (325 mesh, Alfa-Aesar) by Hummer's method was used as the starting material. In a typical procedure, 1 g of graphite oxide was dispersed in 500 g water. After sonication for 2 hours a clear, brown dispersion of graphene oxide was formed. Thereafter, 50 mg of acetylene black was added to the graphene oxide dispersion with stirring. 1 g of hydrazine in 5 grams of water having a pH of about 7-8 (adjusted with NaHCO₃) was added to the mixture. The mixture was maintained at about 80° C. for 1 hr under constant stirring. During reduction, the dark brown dispersion turned black and aggregation was observed at the end of the reduction step. Nanospacer-graphene composite material was separated from the dispersion by filtration. After rinsing with water several times, the nanospacer-graphene composite material was thermally treated in nitrogen at 800° C. for 2 hrs.

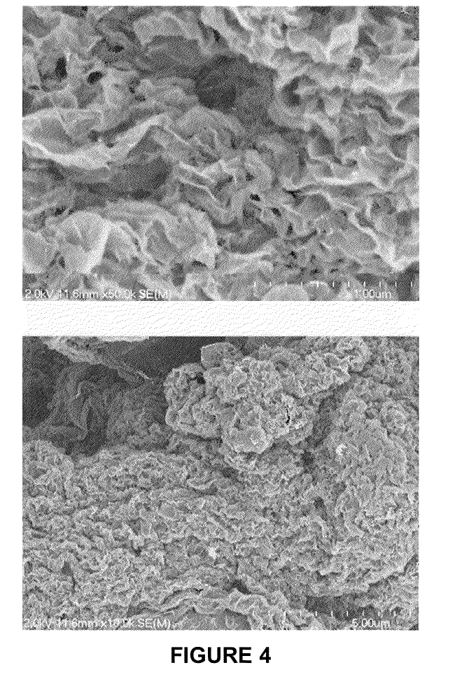

Referring to FIG. 4, SEM images of the nanospacer-graphene composite material having acetylene black as nanospacers can be seen.

### Example 3

Graphite oxide prepared from natural graphite flakes (325 mesh, Alfa-Aesar) by Hummer's method was used as the starting material. In a typical procedure, 1 g of graphite oxide was dispersed in 500 g water. After sonication for 2 hours a clear, brown dispersion of graphene oxide was formed. Thereafter, 9.5 g of 3-(N,N-dimethyldodecylammonio) propane sulfonate and 4.93 g of H₂PtCl₆ in 50 g water was added to the graphene oxide dispersion with stirring. 170 g ethylene glycol was added to the mixture after adjustment to about of about 7-8 using sodium carbonate. The mixture was maintained at about 100° C. for 2 hrs under constant stirring. During reduction, the dark brown dispersion turned black and aggregation was observed at the end of the reduction step. Nanospacer-graphene composite material was separated from the dispersion by filtration. After rinsing with water and methanol thoroughly, the nanospacer-graphene composite material was dried at 70° C. for 15 hrs.

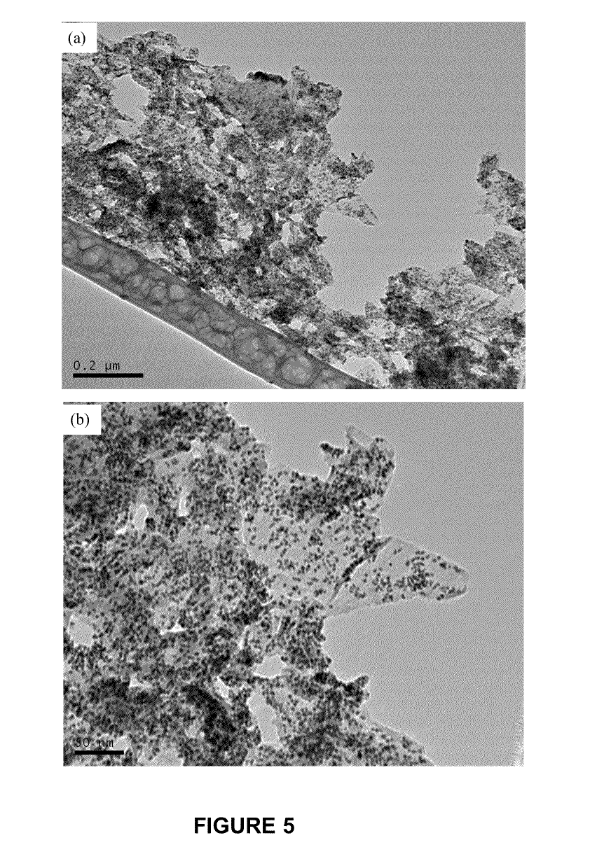

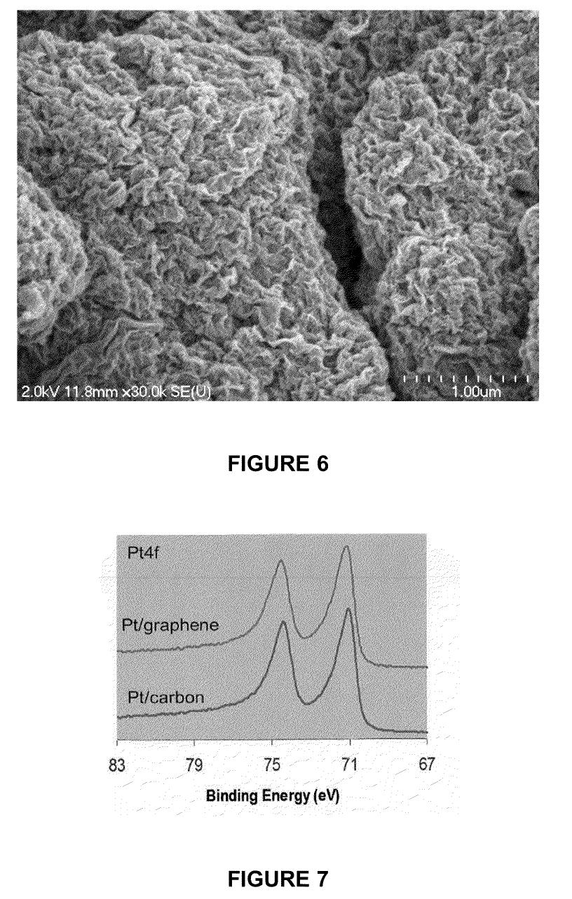

Referring to FIG. 5, SEM images of the nanospacer-graphene composite material having platinum metal as nanospacers can be seen. The platinum nanoparticles appear as dark dots, having a diameter of about 3-5 nm, on the thin graphene sheets. The porosity of the nanospacer-graphene composite material having platinum metal as nanospacers can be seen in FIG. 6. Using XPS, the Pt content in the nanospacer-graphene composite materials was determined to be over 40 wt %, based on the total weight of the composite material.

A Pt4f spectrum of the nanospacer-graphene composite material having platinum metal as nanospacers can be seen in FIG. 7. It can be seen that the Pt/graphene composite exhibits chemical properties identical to commercial Pt/carbon black catalyst. Moreover, as evidenced by the Pt doublet at 71.1 and 74.4 eV, the Pt nanoparticles exist in metallic form.

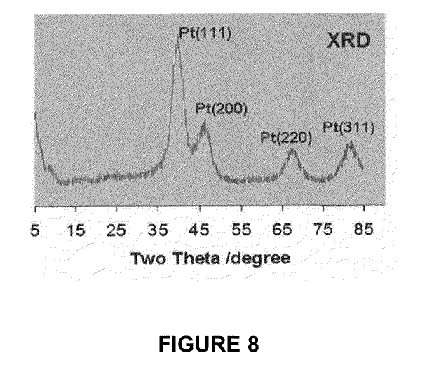

X-ray diffraction (XRD) of Pt-graphene composite material was performed with a Rigaku Multiflex Powder Diffractometer with Cu radiation between 5° and 90° with a scan rate of 0.5° /min and an incident wavelength of 0.154056 nm (Cu Ka). In FIG. 8, the powder X-ray diffraction spectrum of the Pt-graphene composite exhibits the characteristic face-centered cubic (FCC) platinum lattice, confirming that the platinum precursor H₂PtCl₆ has been reduced to platinum.

In addition, surface area measurements confirmed that the surface area of the Pt-graphene composite material is about two times higher than that of plain aggregated graphene sheets. Further, the electrical conductivity of the Pt-graphene composite materials is about four times higher than that of plain graphene.

Accordingly, while the invention has been described herein in reference to specific aspects, features and illustrative embodiments of the invention, it will be appreciated that the utility of the invention is not thus limited, but rather extends to and encompasses numerous other aspects, features and embodiments that result from the adsorption-induced tension in molecular (chemical and physical) bonds of adsorbed macromolecules and macromolecular assemblies. Accordingly, the claims hereafter set forth are intended to be correspondingly broadly construed, as including all such aspects, features and embodiments, within their spirit and scope.

What is claimed is:

1. A nanospacer-graphene composite material.

2. The nanospacer-graphene composite material of claim 1, wherein the nanospacer comprises a nanoparticle selected from the group consisting of fullerene, carbon nanotubes, mesoporous graphite, carbon aerogel, activated carbon, acetylene black, carbon black, graphite, nanodiamonds, lamp black, activated carbon, metal nanoparticles, metal oxides nanoparticles, ceramic nanoparticles, silicon nanoparticles, silicon oxide nanoparticles, polymeric particles, glasses, powders, and any combination thereof.

3. The nanospacer-graphene composite material of claim 1, wherein the nanospacer comprises a nanoparticle selected from the group consisting of fullerene, mesoporous graphite, carbon aerogel, activated carbon, acetylene black, carbon black, graphite, nanodiamonds, lamp black, activated carbon, metal oxides nanoparticles, ceramic nanoparticles, silicon nanoparticles, silicon oxide nanoparticles, polymeric particles, glasses, powders, and any combination thereof.

4. The nanospacer-graphene composite material of claim 1, wherein the graphene is not functionalized with sulfonate moieties.

5. A process of producing nanospacer-graphene composite material, said process comprising:
mixing exfoliated graphene oxide with nanospacer material; and
reducing the exfoliated graphene oxide in the presence of nanospacer material to form the nanospacer-graphene composite material.

6. The process of claim 5, wherein the exfoliate graphene oxide is obtained by agitating graphite oxide.

7. The process of claim 5, wherein the reduction of the exfoliated graphene oxide occurs in a mixture comprising at least one solvent, at least one reducing agent, and nanospacer material.

8. The process of claim 7, wherein the at least one solvent comprises water.

9. The process of claim 7, wherein the at least one reducing agent comprises a species selected from the group consisting of lithium borohydride (LiBH₄), sodium borohydride (NaBH₄), potassium borohydride (KBH₄), rubidium borohydride (RbBH₄), cesium borohydride (CsBH₄), lithium cyanoborohydride (LiBH₃CN), sodium cyanoborohydride (NaBH₃CN), potassium cyanoborohydride (KBH₃CN), rubidium cyanoborohydride (RbBH₃CN), cesium cyanoborohydride (CsBH₃CN), ammonium borohydride (NH₄BH₄), tetramethylammonium borohydride((CH₃)₄NBH₄), dimethylamino borane((CH₃)₂NHBH₃), N,N-diethylaniline borane(C₆H₅N(C₂H₅)₂BH₃), pyridine borane (C₅H₅NBH₃), hydrazine, 1,1-dimethylhydrazine, 1,2-dimethylhydrazine, 1,1-diethylhydrazine, 1,2-diethylhydrazine, 1-ethyl-2-methylhydrazine, 1-acetyl-2-methylhydrazine, 1,1-diethyl-2-propylhydrazine, hydrazine sulfate, sulfonated hydrazine derivatives, and combinations thereof.

10. The process of claim 7, wherein the at least one reducing agent comprises hydrazine.

11. The process of claim 5, wherein the nanospacer material comprises a nanoparticle selected from the group consisting of fullerene, carbon nanotubes, mesoporous graphite, carbon aerogel, activated carbon, acetylene black, carbon black, graphite, nanodiamonds, lamp black, activated carbon, metal nanoparticles, metal oxides nanoparticles, ceramic nanoparticles, silicon nanoparticles, silicon oxide nanoparticles, polymeric particles, glasses, powders, and any combination thereof.

12. The process of claim 5, further comprising rinsing the nanospacer-graphene composite material.

13. The process of claim 12, further comprising thermally processing or drying the nanospacer-graphene composite material.

14. The process of claim 5, wherein the graphene is not functionalized with sulfonate moieties.

15. A process of producing nanospacer-graphene composite material, said process comprising:
mixing exfoliated graphene oxide with at least one metal-containing precursor; and
reducing the exfoliated graphene oxide in the presence of at least one metal-containing precursor to form the nanospacer-graphene composite material,
wherein the graphene is not functionalized with sulfonate moieties.

16. The process of claim 15, wherein the reduction of the exfoliated graphene oxide occurs in a mixture comprising at least one solvent, at least one reducing agent, and at least one metal-containing precursor.

17. The process of claim 16, wherein the mixture further comprises at least one pH adjusting agent, at least one surfactant, or a combination thereof.

18. The process of claim 15, wherein the at least one metal-containing precursor comprises at least one metal ion selected from the group consisting of Pt, Ag, Au, Cu, Ni, Al, Co, Cr, Fe, Mn, Zn, Cd, Sn, Pd, Ru, Os, Ir, and any combination thereof.

19. The process of claim 15, wherein the at least one metal-containing precursor comprises at least one ligand selected from the group consisting of fluoride, chloride, bromide, iodide, β-diketones, nitrate, nitrite, nitride, oxide, oxalate, sulfate, sulfite, sulfide, phosphate, phosphite, phosphide, hydroxide, carbonyl, water, cyanide, ammonia, phosphine, hydroxyl, selenide, and any combination thereof.

20. The process of claim 15, wherein the at least one metal-containing precursor comprises a hexachloroplatinate ion (PtCl₆²⁻).
